(19) United States
(12) Patent Application Publication
(10) Pub. No.: US 2013/0249970 A1
(43) Pub. Date: Sep. 26, 2013

(54) DISPLAY DEVICE, INTEGRATED CIRCUIT, AND CONTROL METHOD

(71) Applicant: SONY CORPORATION, Tokyo (JP)

(72) Inventors: Mitsuyasu Asano, Tokyo (JP); Yasuo Inoue, Tokyo (JP)

(73) Assignee: Sony Corporation, Tokyo (JP)

(21) Appl. No.: 13/765,740

(22) Filed: Feb. 13, 2013

(30) Foreign Application Priority Data
Mar. 23, 2012 (JP) 2012067034

(51) Int. Cl. G09G 3/22

(52) U.S. Cl. CPC G09G 3/22
USPC 345/691

(57) ABSTRACT

There is provided a display device including a temporal direction control unit that causes a gain used to control a video signal to respond to an input video signal at high speed when the input video signal sharply increases, and causes the gain to respond to the input video signal at low speed when the input video signal gently increases.

### BACKGROUND

The present disclosure relates to a display device, an integrated circuit, and a control method.

A self luminous type display device displays an image by causing a light-emitting element to emit light with luminance in accordance with an input current value. When an image signal or a video signal with a signal intensity equal to or greater than a given value is input, an overcurrent may flow in the light-emitting element of the display device.

Accordingly, when the image signal or the video signal with the signal intensity equal to or greater than the given value is input, auto-brightness limiter (ABL) control of limiting luminance is performed by performing gain control so that the overcurrent does not flow in the light-emitting element. For example, PCT International Patent Application Publication No. WO2008/143208 discloses an ABL control method of performing feed-forward control so that an average current value of an image signal or a video signal input to a display unit does not exceed a given threshold value.

### SUMMARY

In a technology disclosed in PCT International Patent Application Publication No. WO2008/143208, a speed at which a gain responds to an input signal is not considered in the ABL control,

For this reason, when an increase and a decrease in the average current value of the input signal are repeated, an increase and a decrease in the gain are repeated with the change in the average current value. As a result, since an increase or a decrease in the luminance of an image displayed on the display unit is repeated, image quality may deteriorate.

It is desirable to provide a novel and improved display device, a novel and improved integrated circuit, and a novel and improved control method capable of performing ABL control of automatically adjusting a speed at which a gain is caused to respond to an input signal.

According to an embodiment of the present disclosure, there is provided a display device including a temporal direction control unit that causes a gain used to control a video signal to respond to an input video signal at high speed when the input video signal sharply increases, and causes the gain to respond to the input video signal at low speed when the input video signal gently increases.

Further, according to an embodiment of the present disclosure, there is provided an integrated circuit having a temporal direction control function of causing a gain used to control a video signal to respond to an input video signal at high speed when the input video signal sharply increases, and causes the gain to respond to the input video signal at low speed when the input video signal gently increases.

Further, according to an embodiment of the present disclosure, there is provided a control method including causing a gain used to control a video signal to respond to an input video signal at high speed when the input video signal sharply increases, and causes the gain to respond to the input video signal at low speed when the input video signal gently increases.

According to the embodiments of the present disclosure described above, it is possible to provide the novel and improved display device, the novel and improved integrated circuit, and the novel and improved control method capable of performing the ABL control of automatically adjusting a speed at which a gain is caused to respond to an input signal.

### BRIEF DESCRIPTION OF THE DRAWINGS

FIG. 1 is a diagram illustrating ABL control in which temporal direction control is not performed;

FIG. 2 is a diagram illustrating linear conversion;

FIG. 3 is a diagram illustrating γ conversion;

FIG. 4 is a diagram illustrating the ABL control when a telop appears or disappears;

FIG. 5 is a diagram illustrating a gain change caused due to the appearance or disappearance of the telop;

FIG. 6 is a diagram illustrating the overall configuration of a display device according to a first embodiment of the present disclosure;

FIG. 7 is a diagram illustrating a process performed by a temporal direction control unit according to the embodiment;

FIG. 8 is a diagram illustrating a temporal change of an output value when control of causing a gain to respond at high speed is performed;

FIG. 9 is a diagram illustrating a temporal change of an output value when control of causing a gain to respond at low speed is performed;

FIG. 10 is a diagram illustrating a response control value input to the temporal direction control unit according to the embodiment;

FIG. 11 is a diagram illustrating an example of the configuration of the temporal direction control unit according to the embodiment;

FIG. 12 is a diagram illustrating an example of the configuration of a control value selection unit according to the embodiment;

FIG. 13 is a diagram illustrating an example of the flow of a process performed by an ABL control unit according to the embodiment;

FIG. 14 is a diagram illustrating an example of the flow of a process performed by the temporal direction control unit according to the embodiment;

FIG. 15 is a diagram illustrating an example of the flow of a process performed by the control value selection unit according to the embodiment;

FIG. 16 is a diagram illustrating advantages according to the embodiment;

FIG. 17 is a diagram for describing a first modification example of the technology of the embodiment;

FIG. 18 is a diagram for describing a second modification example of the technology of the embodiment;

FIG. 19 is a diagram for describing a third modification example of the technology of the embodiment; and

FIG. 20 is a diagram for describing a fourth modification example of the technology of the embodiment.

### DETAILED DESCRIPTION OF THE EMBODIMENTS

Hereinafter, preferred embodiments of the present disclosure will be described in detail with reference to the appended drawings. Note that, in this specification and the appended drawings, structural elements that have substantially the same function and structure are denoted with the same reference numerals, and repeated explanation of these structural elements is omitted.

The description will be made in the following order.

1. Introduction

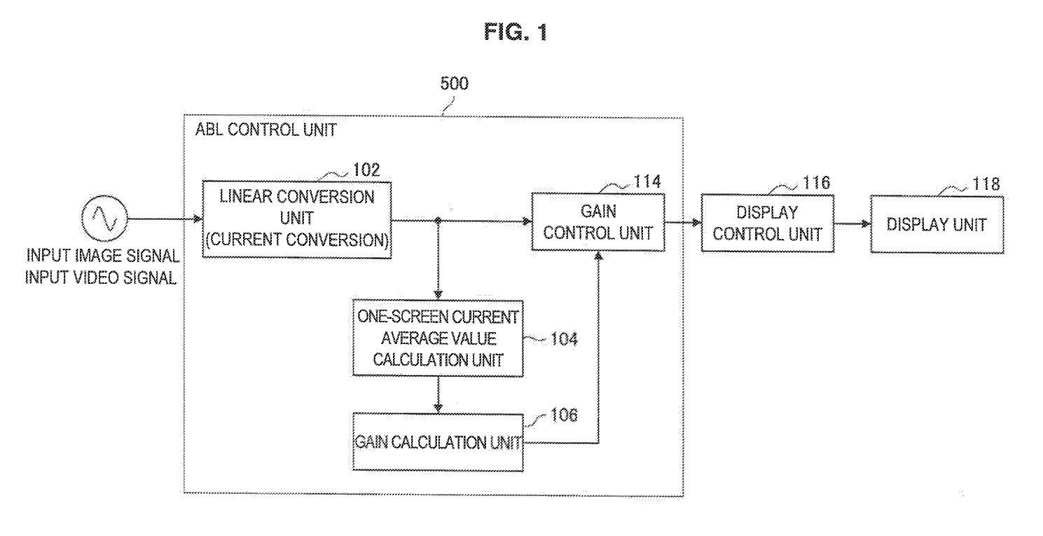

1-1. ABL Control in Which Temporal Direction Control Is Not Performed (FIG. 1)

1-2. Example of ABL Control When Telop Appears or Disappears (FIG. 4)

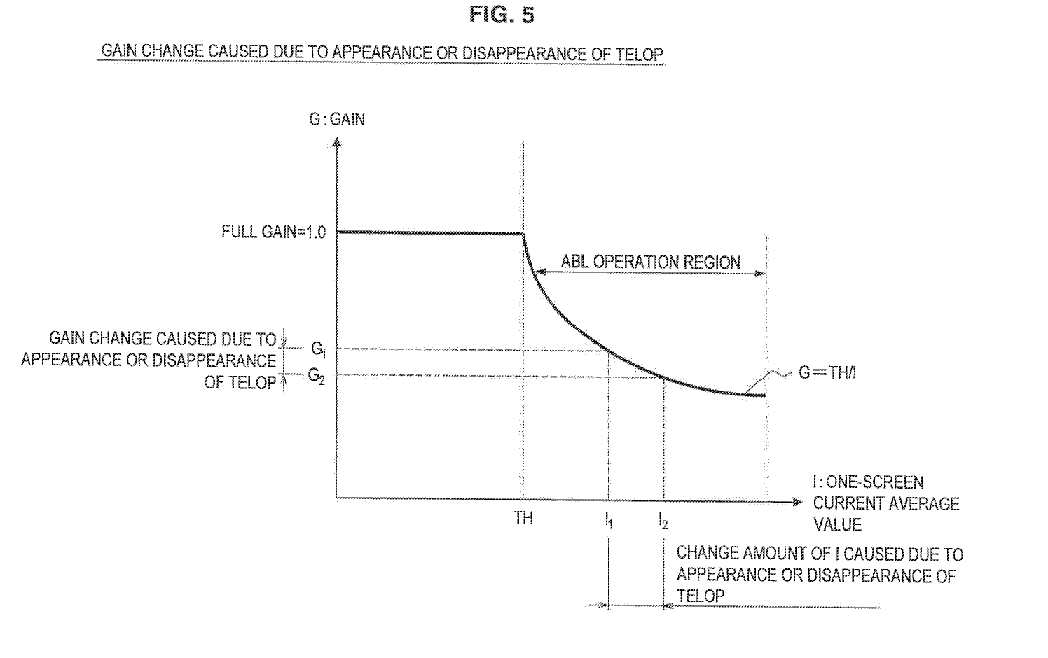

1-3. Gain Change When Telop Appears or Disappears (FIG. 5)

2. Basic Configuration (ABL Control in Which Temporal Direction Control Is Performed)

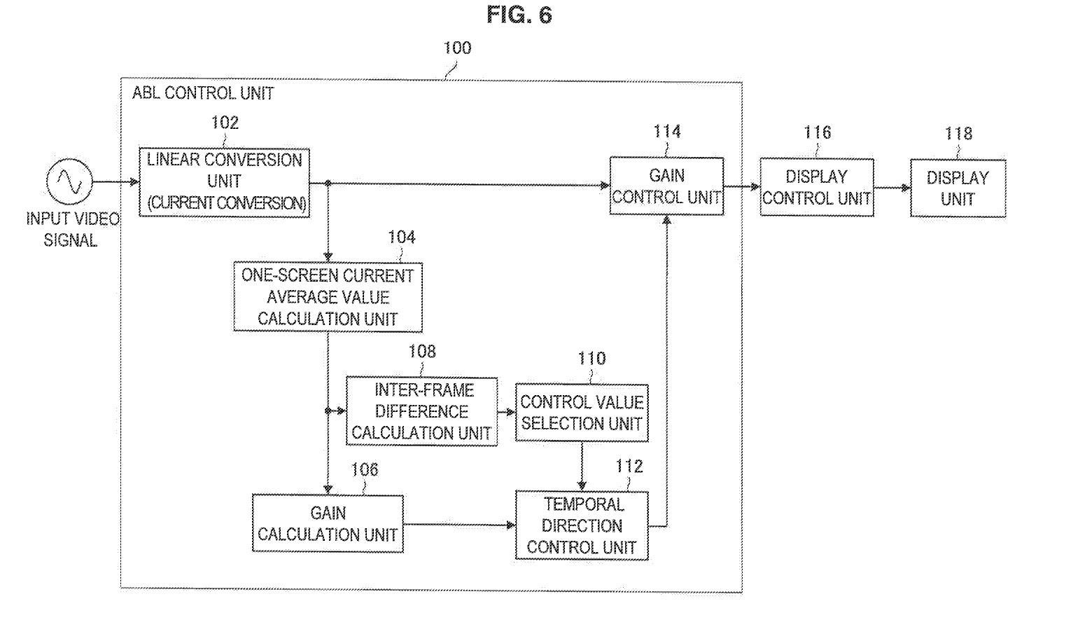

2-1. Configuration of Display Device 10 (FIG. 6)

2-2. Temporal Direction Control Unit 112

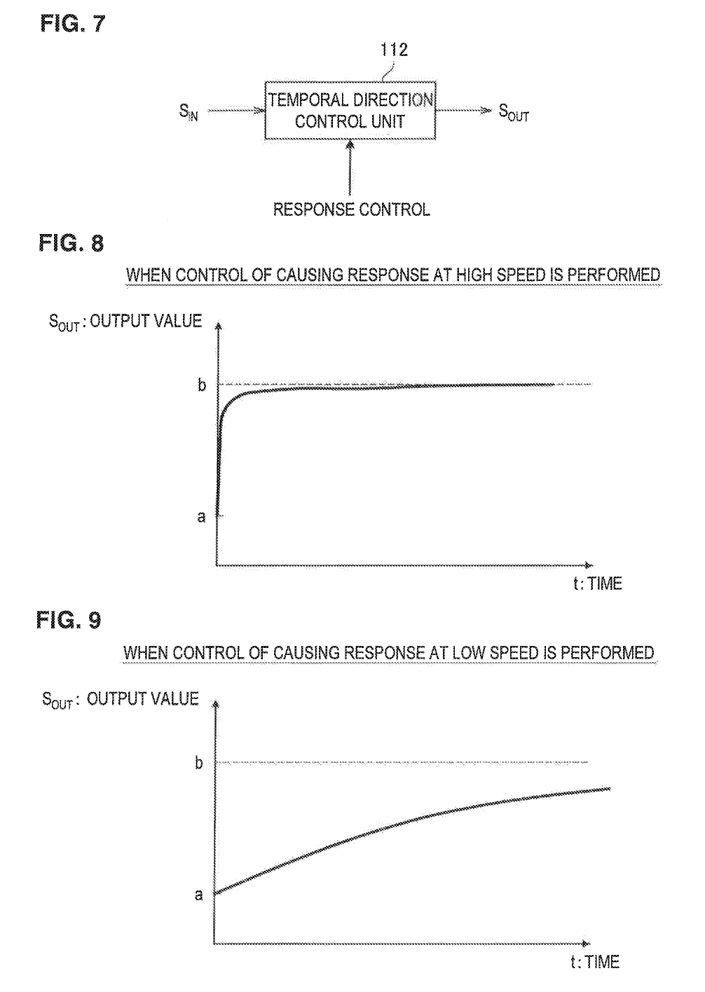

2-2-1. Process Performed by Temporal Direction Control Unit 112 (FIG. 7)

2-2-2. Case in Which Control of Causing Gain to Respond at High Speed Is Performed (FIG. 8)

2-2-3. Case in Which Control of Causing Gain to Respond at Low Speed Is Performed (FIG. 9)

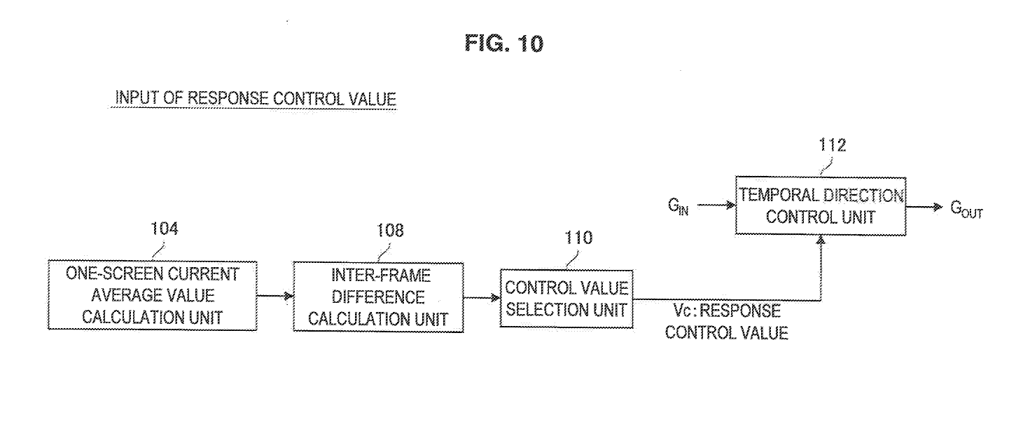

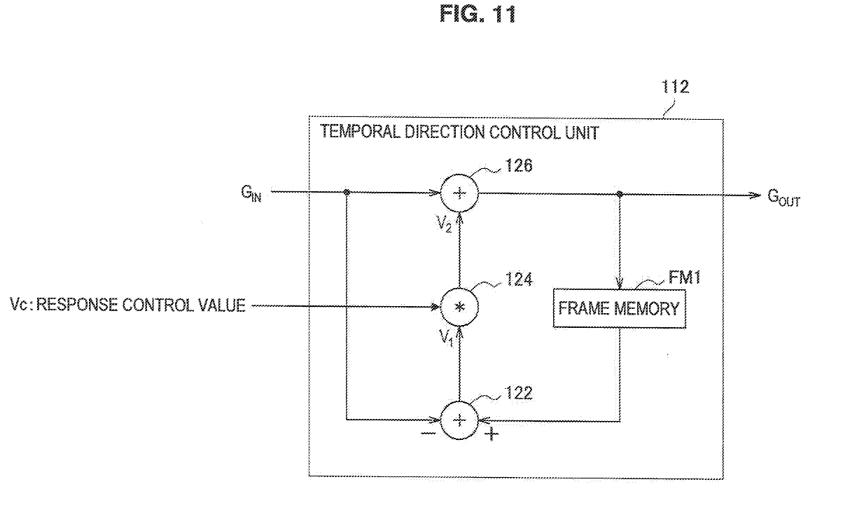

2-2-4. Response Control Value to Be Input (FIG. 10)

2-2-5. Example of Configuration of Temporal Direction Control Unit 112 (FIG. 11)

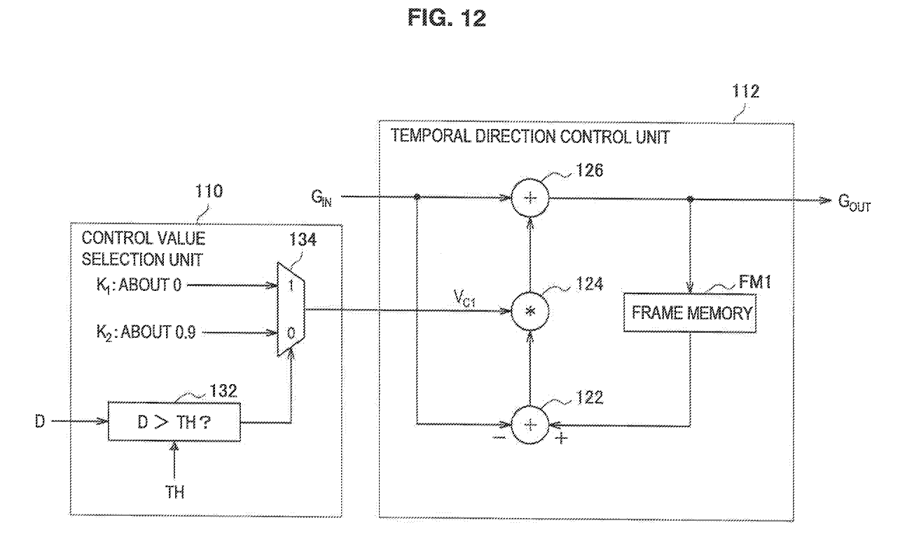

2-3. Process Performed by Control Value Selection Unit 110 (FIG. 12)

2-4. Flow of Process

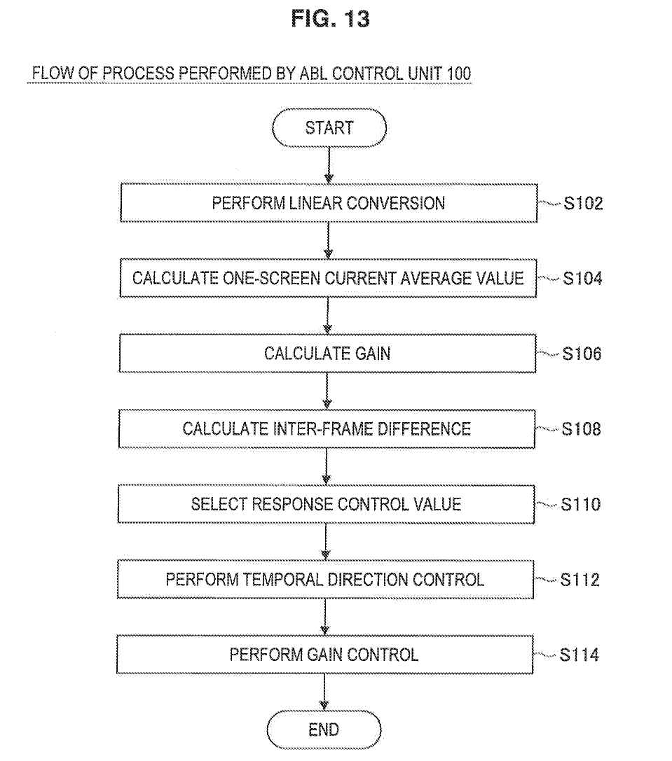

2-4-1. Flow of Process Performed by ABL Control Unit 100 (FIG. 13)

2-4-2. Flow of Process Performed by Temporal Direction Control Unit 112 (FIG, 14)

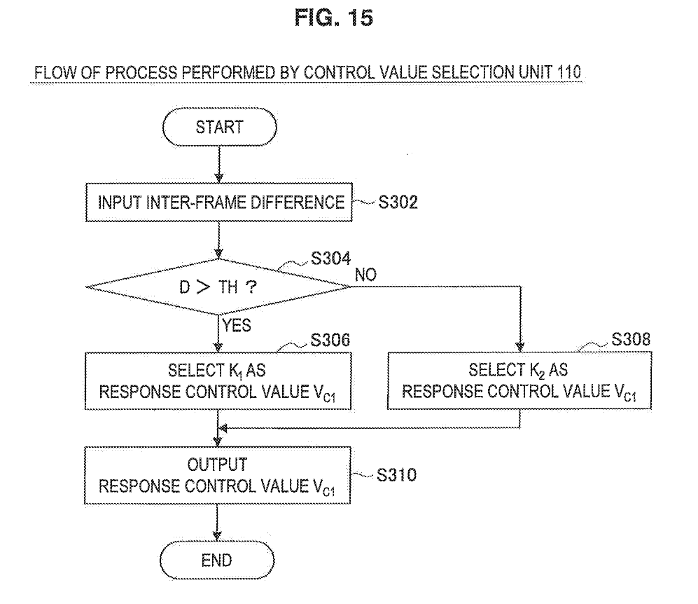

2-4-3. Flow of Process Performed by Control Value Selection Unit 110 (FIG. 15)

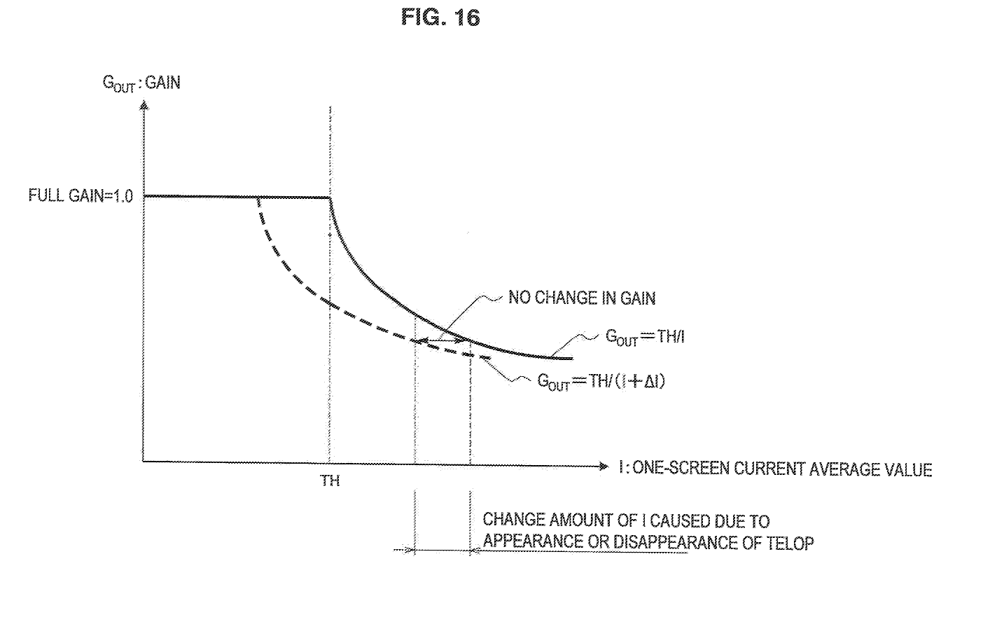

2-5. Advantages of Temporal Direction Control (FIG. 16)

3. Modification Examples

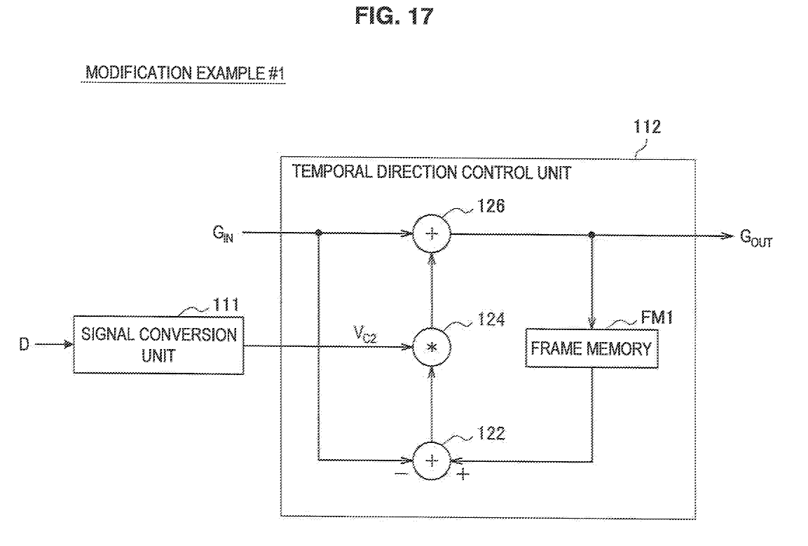

3-1. First Modification Example (Calculation of Response Control Value by Signal Conversion: FIG. 17)

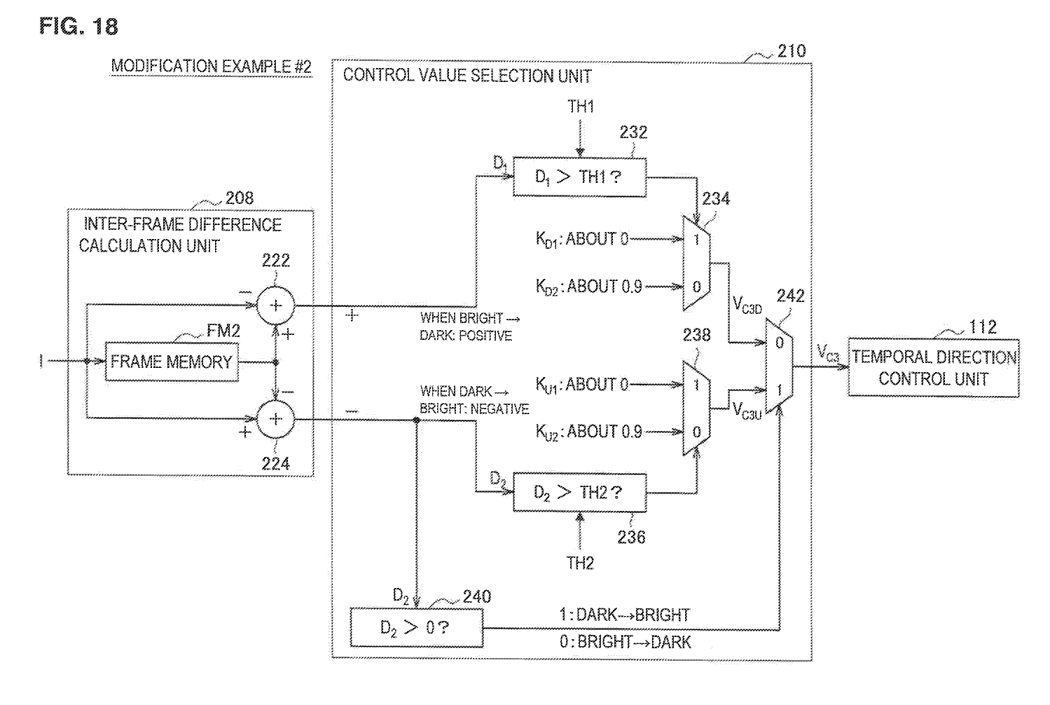

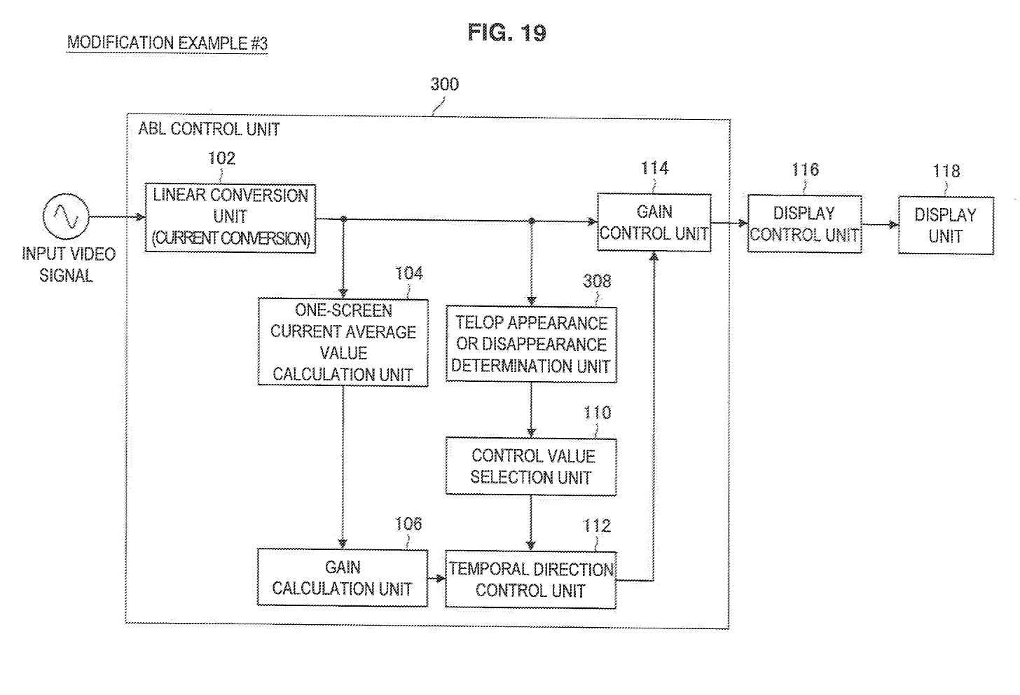

3-2. Second Modification Example (Selection of Response Control Value Based on Two Threshold Values: FIG. 18)

3-3. Third Modification Example (Use of Telop Presence and Absence Information: FIG. 19)

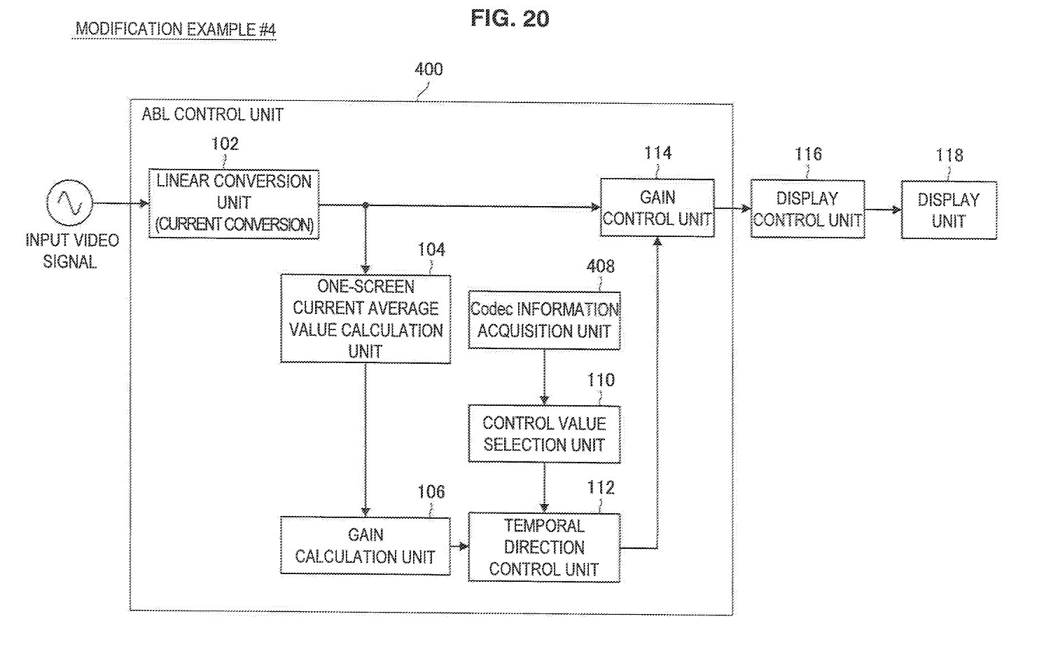

3-4. Fourth Modification Example (Use of Codec Information: FIG. 20)

4. Summarization

### 1. INTRODUCTION

### 1-1. ABL CONTROL IN WHICH TEMPORAL DIRECTION CONTROL IS NOT PERFORMED (FIG. 1)

First, ABL control in which temporal direction control is not performed will be described with reference to FIGS. 1 to 3.

The ABL control is performed on a self-luminous type display device such as an organic light-emitting diode (OLED) display, a field emission display (FED), a surface-conduction electron-emitter display (SED), or a plasma display panel (PDP).

FIG. 1 is a diagram illustrating the ABL control in which the temporal direction control is not performed. As shown in FIG. 1, an image signal or a video signal is input to a display device including an ABL control unit 500. However, the image signal or the video signal may not he a signal configured to realize an optimum display state when the signal is displayed on a display unit 118 to be described below.

Therefore, a linear conversion unit 102 of the ABL control unit 500 performs linear conversion (window level conversion) to convert the input image signal or the input video signal into an optimum signal for the display unit 118. An overview of the linear conversion and a process performed by the linear conversion unit 102 will be described below.

The linear conversion is a process of converting an image signal or a video signal compressed in a γ space into a value proportional to an optical intensity (luminance). As described above, since luminance and a current value have a proportional relation, the process of converting an image signal or a video signal into luminance is equivalent to a process of converting an image signal or a video signal into a current value.

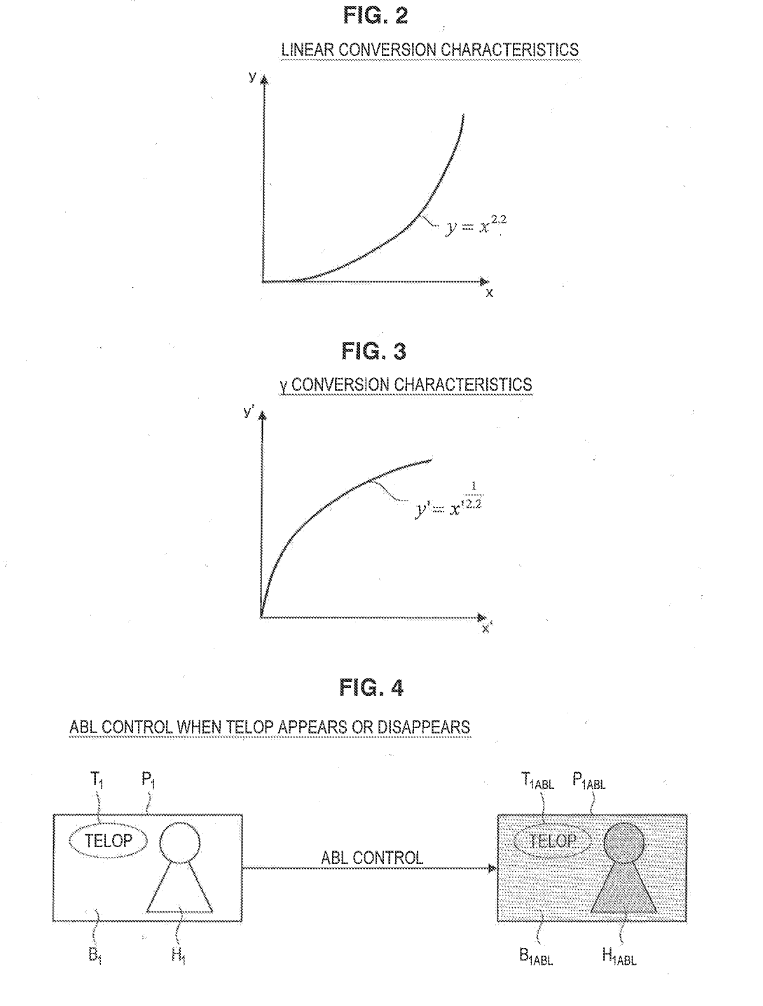

FIG. 2 is a diagram illustrating the linear conversion. Here, x represents an image signal or a video signal compressed in a y space. Further, y represents a signal proportional to an optical intensity (luminance). In the linear conversion, for example, as shown in FIG. 2, an image signal or a video signal x compressed in the γ space is converted into a signal y proportional to the optical intensity (luminance) according to a function y=x^{2.2}.

The overview of the linear conversion and the process performed by the linear conversion unit 102 has been described. Next, a process performed by a one-screen current average value calculation unit 104 will be described.

A current value is input as the image signal converted by the linear conversion unit 102 to the one-screen current average value calculation unit 104. The one-screen current average value calculation unit 104 calculates an average value of the current values of the pixels included in the input image. Further, when the video signal is input to the one-screen current average value calculation unit 104, an average value of the current values of the pixels included in each frame is calculated.

In the embodiment of the present disclosure, an average value of the current values calculated for the pixels included in an input image or the pixels included in each frame of an input video signal is referred to as a one-screen current average value. The one-screen current average value calculation unit 104 outputs the calculated one-screen current average value to a gain calculation unit 106. Further, one screen indicates a one-screen image in an image signal or one frame in a video signal.

The gain calculation unit 106 calculates a gain used to adjust the luminance of each screen based on the input one-screen current average value. A gain calculation method of the gain calculation unit 106 is classified as one of the following two methods based on the input one-screen current average value.

### (Case in Which Input One-Screen Current Average Value is Smaller Than Threshold Value TH)

The gain calculation unit 106 calculates a gain G as 1.0 (full gain). When the input one-screen current average value I is equal to or less than a threshold value TH, this value is input to the display unit 118 without change. This is because no overcurrent flows in a light-emitting element of the display unit 118.

### (Case in Which Input One-Screen Current Average Value is Equal to or Less Than Threshold Value TH)

The gain calculation unit 106 calculates the gain G according to a function G=TH/I. Further, I is the one-screen current average value input to the gain calculation unit 106. The gain G is calculated such that the gain G is smaller in inverse proportion to the one-screen current average value I as the input one-screen current average value I is larger.

When the input one-screen current average value I is equal to or greater than the threshold value TH and the unchanged value is input to the display unit 118, an overcurrent flows in the light-emitting element of the display unit 118. Therefore, by adjusting the gain G to be inversely proportional to the one-screen current average value I, the overcurrent is prevented from flowing in the light-emitting element of the display unit 118.

When the gain calculation unit 106 calculates the gain according to one of the two gain calculation methods, the calculated gain is output to the gain control unit 114.

As described above, the image signal or the video signal converted by the linear conversion unit 102 is input to the gain control unit 114. Further, as described above, the gain of each screen calculated by the gain calculation unit 106 is input to the gain control unit 114.

The gain control unit 114 generates an image signal or a video signal to be input to the display unit 118 by multiplying the current value of each pixel included in the image or the video subjected to the linear conversion by the calculated gain.

When the calculated one-screen current average value is less than the threshold value TH, the image signal or the video signal subjected to the linear conversion is input to the display unit 118 without change. Conversely, when the calculated one-screen current average value is equal to or greater than the threshold value TH, a value obtained by multiplying the current value of the image signal or the video signal subjected to the linear conversion by the gain G is input as the image signal or the video signal to the display unit 118.

The gain control unit 114 outputs the image signal or the video signal subjected to the gain control to the display control unit 116. The display control unit 116 performs display control of the display unit 118 based on the input image signal or the input video signal. When a signal of a γ space is necessary in the input of the image signal to the display unit 118, it is necessary for the linear conversion unit 102 to convert the signal subjected to the linear conversion into a signal of the y space again. When a signal proportional to an optical intensity (luminance) is necessary in the input of the image signal to the display unit 118, the signal subjected to the linear conversion may be used.

FIG. 3 is a diagram illustrating y conversion. Here, x′ indicates a signal proportional to the optical intensity (luminance). Further, y′ indicates an image signal or a video signal compressed in the γ space. In the γ conversion, for example, as shown in FIG. 3, the signal x′ proportional to the optical intensity (luminance) is converted again into a signal y′ of the γ space according to a function x′^{1/2.2}.

The ABL control in which the temporal direction control is not performed has been described with reference to FIGS. 1 to 3.

### 1-2. EXAMPLE OF ABL CONTROL WHEN TELOP APPEARS OR DISAPPEARS (FIG. 4)

Next, a phenomenon occurring in the ABL control when a video signal in which a telop appears or disappears in the middle of a picture is input will be described with reference to FIG. 4. FIG. 4 is a diagram illustrating the ABL control when a telop appears or disappears.

As shown in FIG. 4, a case in which a human H₁, a background B₁, and a telop T₁ are included in a frame P₁ to be subjected to the ABL control will he considered. Here, it is assumed that no telop is included in a frame P₀ previous to the frame P₁ and a telop appears in the frame P₁.

It is necessary for the ABL control unit 100 to perform a process on the input video signal in real time and output the video signal to the display unit 118. Therefore, in the ABL control, a gain used to control the input video signal is generally calculated for each frame. That is, the input video signal is not controlled for each pixel included in a frame.

When the telop T₁ appears, a current average value of the entire frame P₁ becomes higher. When the one-screen current average value of the frame P₁ is equal to or greater than the threshold value TH in the calculation of the gain, the input frame P₁ is controlled as in a frame P_{1ABL} through the ABL control and is displayed on the display unit 118.

As shown in FIG. 4, in the frame P_{1ABL} obtained after the ABL control, a portion, such as a human H_{1ABL} or a background B_{1ABL}, in which a luminance is desired to he stable, other than a telop T_{1ABL} may he instantly darkened in some cases, when the telop appears.

Further, when the telop disappears, a change in the luminance may occur. Even in this case, the ABL control on the entire screen may result in the instant change in the luminance of the portion of the human or the background other than the telop.

The phenomenon occurring in the ABL control when a video signal in which a telop appears or disappears in the middle of a picture is input has been described with reference to FIG. 4.

### 1-3. GAIN CHANGE WHEN TELOP APPEARS OR DISAPPEARS (FIG. 5)

Next, a gain change caused due to the appearance or disappearance of a telop will be described with reference to FIG. 5. FIG. 5 is a diagram illustrating the gain change caused due to the appearance or disappearance of a telop.

As shown in FIG. 5, the gain calculation unit 106 calculates a gain G as a full gain of 1.0 until the input one-screen current average value I is the threshold value TH. The gain calculation unit 106 calculates the gain G according to a function G=TH/I in an ABL operation region in which the input one-screen current average value I is equal to or greater than the threshold value TH.

When the one-screen current average value I increases from I₁ to I₂ due to the appearance of a telop in the ABL operation region, the gain G decreases from G₁ to G₂ with the increase. Further, when the one-screen current average value I decreases from I₂ to I₁ due to disappearance of the telop, the gain G increases from G₂ to G₁ with the decrease.

Thus, even when the input signal of only a part of a screen is changed due to, for example, the appearance or disappearance of the telop, the gain of the screen may be changed and the luminance of the screen obtained after the ABL control may be changed in a short time. The sharp change in the luminance of temporally continuous moving image contents in the temporal direction is easily perceived by a human and causes a deterioration in image quality.

On the other hand, when an input signal of the entire screen is changed in reproduction of moving image contents, it is also necessary to adjust the gain quickly so that an overcurrent does not flow in terms of protection of the light-emitting element of the display unit 118 or a power source.

As the result of thorough examination based on such a phenomenon, the present inventors have devised the following technology capable of appropriately selecting fast adjustment of the gain with respect to the input video signal (in other words, the gain is caused to respond at high speed) or slow adjustment of the gain (in other words, the gain is caused to respond at low speed).

Specifically, the present inventors have contrived ABL control in which the gain is caused to respond to the input video signal at high speed when the current value of the video signal input to the display device sharply increases, whereas the gain is caused to respond to the input video signal at low speed when the current value of the video signal input to the display device gently increases.

### 2. BASIC CONFIGURATION (ABL CONTROL IN WHICH TEMPORAL DIRECTION CONTROL IS PERFORMED)

### 2-1. CONFIGURATION OF DISPLAY DEVICE 10 (FIG. 6)

Next, the entire configuration of the display device 10 according to the first embodiment of the present disclosure will be described with reference to FIG. 6. FIG. 6 is a diagram illustrating the entire configuration of the display device 10 according to the first embodiment of the present disclosure. The display device 10 is, for example, a digital still camera capable of photographing a still image, a video camera capable of photographing a moving image, or a cellular phone, a game device, an information terminal, or a personal computer having the same imaging function as the digital still camera or the video camera.

The entire configuration of the display device 10 shown in FIG. 6 is merely an example, and some of the constituent units may he changed, added, or deleted. The entire configuration of the display device 10 will be described below with reference to FIG. 6. Here, the basic configuration of the display device 10 to be shown will be described on the assumption of a case in which the luminance of a video increases mainly due to appearance or the like of a telop. This is because a case in which the ABL control is necessary is mainly a case in which the luminance of a video instantly increases.

The display device 10 mainly includes an ABL control unit 100, the display control unit 116, and the display unit 118. The ABL control unit 100 includes a linear conversion unit 102, a one-screen current average value calculation unit 104, a gain calculation unit 106, an inter-frame difference calculation unit 108, a control value selection unit 110, a temporal direction control unit 112, and a gain control unit 114.

Among the constituent units of the ABL control unit 100, the functions of the linear conversion unit 102, the one-screen current average value calculation unit 104, the gain calculation unit 106, and the gain control unit 114 are the same as those of the constituent units of the ABL control unit 500 which does not perform the temporal direction control.

A video signal input to the display device 10 is subjected to linear conversion by the linear conversion unit 102. The linear conversion unit 102 outputs the video signal subjected to the linear conversion to the one-screen current average value calculation unit 104 and the gain control unit 114.

When the one-screen current average value calculation unit 104 calculates a one-screen current average value of each frame of the video signal, the one-screen current average value calculation unit 104 outputs the calculated one-screen current average value to the gain calculation unit 106 and the inter-frame difference calculation unit 108.

When the gain calculation unit 106 calculates the gain based on the one-screen current average value, the gain calculation unit 106 outputs the calculated gain to the temporal direction control unit 112.

The inter-frame difference calculation unit 108 calculates a difference (hereinafter referred to as an inter-frame difference) between a one-screen current average value of an input frame and a one-screen current average value of a previously input frame of the frame. The inter-frame difference calculation unit 108 outputs the calculated inter-frame difference to the control value selection unit 110.

When the luminance of only a partial region included in a frame is changed due to, for example, the appearance or disappearance of a telop, the change in the one-screen current average value of the entire frame is small. Therefore, the inter-frame difference is smaller, compared to a case, such as a scene changeover of moving image contents, in which the luminance of the entire frame is changed.

That is, by calculating the inter-frame difference, it is possible to determine whether the luminance of the entire frame of an input video signal is changed or only the luminance of a part of the frame of an input video signal is changed.

The control value selection unit 110 selects a response control value of the temporal direction control unit from two kinds of values based on the input inter-frame difference. The details of a process performed by the control value selection unit 110 will be described below. The control value selection unit 110 outputs the calculated response control value to the temporal direction control unit 112.

The temporal direction control unit 112 controls the temporal direction characteristics of the gain input from the gain calculation unit 106 based on the response control value input from the control value selection unit 110. Specifically, the gain calculation unit 106 increases or decreases the response speed of the gain with respect to the input video signal by adjusting the gain calculated by the gain calculation unit 106 based on the response control value.

A process performed by the temporal direction control unit 112 will be described below. The temporal direction control unit 112 outputs the adjusted gain to the gain control unit 114.

The gain control unit 114 performs gain control of the video signal based on the video signal subjected to the linear conversion and input from the linear conversion unit 102 and the gain input from the temporal direction control unit 112. The display control unit 116 performs display control of the display unit 118 based on the video signal obtained after the gain control.

One frame is a unit of the process performed by each unit, but the technical application scope of this embodiment of the present disclosure is not limited thereto. For example, one frame may be divided into a plurality of regions, an average current value of each of the divided regions may be calculated, and the gain control may be performed based on the calculated average current values.

In the above-described configuration, the ABL control appropriate for each frame region can be performed.

The entire configuration of the display device 10 has been described with reference to FIG. 6.

### 2-2. TEMPORAL DIRECTION CONTROL UNIT 112

### 2-2-1. PROCESS PERFORMED BY TEMPORAL DIRECTION CONTROL UNIT 112 (FIG. 7)

Next, a process performed by the temporal direction control unit 112 will be described below with reference to FIGS. 7 to 9. FIG. 7 is a diagram illustrating the process performed by the temporal direction control unit 112 according to this embodiment, FIG. 8 is a diagram illustrating a temporal change of an output value when control of causing the gain to respond at high speed is performed. FIG. 9 is a diagram illustrating a temporal change of an output value when control of causing the gain to respond at low speed is performed.

As shown in FIG. 7 the temporal direction control unit 112 controls a response speed of an output value S_{OUT} with respect to an input value S_{IN}. In the temporal direction control unit 112, a case in which the response speed of the output value S_{OUT} with respect to an input value S_{IN} is low refers to a case in which the change of the output value S_{OUT} is small even when the input value S_{IN} is changed. In other words, the temporal direction control unit 1.12 calculates the output value S_{OUT} so that the value of the immediately previous output value S_{OUT} is maintained.

Further, a case in which the response speed of the output value S_{OUT} with respect to a change in an input value S_{IN} is high refers to a case in which the output value S_{OUT} quickly responds when the input value S_{IN} is changed.

How quickly the temporal direction control unit 112 changes the output value S_{OUT} with respect to the change in the input value S_{IN} can be controlled from the outside of the of the temporal direction control unit 112.

In the display device 10, the input value S_{IN} of the temporal direction control unit 112 is a gain calculated by the gain calculation unit 106. Further, the output value S_{OUT} of the temporal direction control unit 112 is a gain that is used when the gain control unit 114 performs the gain control on the input video signal.

### 2-2-2. CASE IN WHICH CONTROL OF CAUSING GAIN TO RESPOND AT HIGH SPEED IS PERFORMED (FIG. 8)

FIG. 8 shows a temporal change of the output value S_{OUT} when the input value S_{IN} is changed from a to b. In FIG. 8, t=0 refers to a moment at which the input value S_{IN} is changed from a to b.

As shown in FIG. 8, when the control of causing the gain to respond at high speed is performed, the output value S_{OUT} is also sharply changed from a to b in response to the change in the input value S_{IN}. The input value S_{IN} input to the temporal direction control unit 112 of the display device 10 is a gain. G_{IN} which is calculated by the gain calculation unit 106 based on the input video signal. Further, the output value S_{OUT} from the temporal direction control unit 112 of the display device 10 is a gain G_{OUT} which is input to the gain control unit 114.

As in FIG. 8, when the response control is performed by the temporal direction control unit 112, the gain G_{OUT} input to the gain control unit 114 responds at high speed to the gain G_{IN} calculated by the gain calculation unit 106.

That is, the gain G_{OUT} input to the gain control unit 114 responds at high speed to the change in the input video signal.

As a result, by performing the display control quickly in response to the change in the input video signal, it is possible to prevent an overcurrent from flowing in the light-emitting element.

### 2-2-3. CASE IN WHICH CONTROL OF CAUSING GAIN TO RESPOND AT LOW SPEED IS PERFORMED (FIG. 9)

FIG. 9 shows a temporal change of the output value S_{OUT} when the input value S_{IN} is changed from a to b, as in FIG. 8.

As in FIG. 9, when the control of causing the gain to respond at low speed is performed, a time from the time t=0 at which the input value S_{IN} is changed to a time at which the output value S_{OUT} becomes b is lengthened, compared to FIG. 8. The output value S_{OUT} is gently changed from a to b.

The input value S_{IN} input to the temporal direction control unit 112 of the display device 10 is a gain G_{IN} that is calculated by the gain calculation unit 106 based on the input video signal. Further, the output value S_{OUT} from the temporal direction control unit 112 of the display device 10 is a gain G_{OUT} that is input to the gain control unit 114.

As in FIG. 9, when the response control is performed by the temporal direction control unit 112, the gain G_{OUT} input to the gain control unit 114 responds at low speed to the gain G_{IN} calculated by the gain calculation unit 106.

That is, the gain G_{OUT} input to the gain control unit 114 responds at low speed to the change in the input video signal.

As a result, even when a part of the input video signal is changed, the luminance of the display unit 118 is stable, and thus it is possible to prevent image quality from deteriorating.

### 2-2-4. RESPONSE CONTROL VALUE TO BE INPUT (FIG. 10)

Next, a response control value input to the temporal direction control unit 112 will be described below with reference to FIG. 10. FIG. 10 is a diagram illustrating the response control value input to the temporal direction control unit 112 according to this embodiment.

The one-screen current average value calculation unit 104 calculates a one-screen current average value of each frame of the video signal input to the display device 10. The inter-frame difference calculation unit 108 calculates a difference (inter-frame difference) in the one-screen current average value between the frames calculated by the one-screen current average value calculation unit 104.

The control value selection unit 110 calculates a response control value V_{C} used to perform the response control of the temporal direction control unit 112 according to the inter-frame difference calculated by the inter-frame difference calculation unit 108, and then input the calculated control value V_{C} to the temporal direction control unit 112.

The process performed by the temporal direction control unit 112 has been described with reference to FIGS. 7 to 10.

### 2-2-5. EXAMPLE OF CONFIGURATION OF TEMPORAL DIRECTION CONTROL UNIT 112 (FIG. 11)

Next, an example of the configuration of the temporal direction control unit 112 performing the above-described process will be described below with reference to FIG. 11. FIG. 11 is a diagram illustrating an example of the configuration of the temporal direction control unit 112 according to this embodiment.

The gain G_{IN} calculated by the gain calculation unit 106 is input to the temporal direction control unit 112. The gain G_{IN} input to the temporal direction control unit 112 is input to addition units 122 and 126.

Here, the gain G_{OUT} calculated through various kinds of calculation of the temporal direction control unit 112 is temporarily stored in a frame memory FM1 of the temporal direction control unit 112 and is used for calculation. The value of the gain G_{IN} input at a given moment and stored at the moment in the frame memory FM1 is the gain G_{OUT} calculated based on the previously input gain G_{IN}.

The addition unit 122 adds a value obtained by inverting the sign of the input gain G_{IN} and the value stored in the frame memory FM1. The addition unit 122 outputs a calculated value V₁ to a multiplication unit 124. The value V₁ output from the addition unit 122 is a value obtained by subtracting the gain G_{IN} input at the given moment from the gain G_{OUT} output immediately before the moment.

When the gain G_{IN} smaller than the immediately output gain G_{OUT} is input to the addition unit 122, the value V₁ output from the addition unit 122 becomes positive. Conversely, when the gain G_{IN} larger than the immediately output gain G_{OUT} is input to the addition unit 122, the value V output from the addition unit 122 becomes negative.

The multiplication unit 124 multiples the value V₁ output from the addition unit 122 by the response control value V_{C}. The multiplication unit 124 outputs a calculated value V₂ to the addition unit 126. The addition unit 126 adds the input gain G_{IN} and the value V₂ input by the multiplication unit 124. The addition unit 12.6 outputs the calculated value as the gain G_{OUT} output by the temporal direction control unit 112.

Here, the response control value V_{C} input to the multiplication unit 124 is a value greater than 0 and less than 1. As the response control value V_{C} is closer to 0, the influence of the value V₁ calculated based on the value stored in the frame memory FM1 is smaller in the calculation of the addition unit 126. That is, the gain is caused to respond at high speed according to the change in the input video signal.

Further, as the response control value V_{C} is closer to 1, the influence of the value V₁ calculated based on the value stored in the frame memory FM1 is larger in the calculation of the addition unit 126. That is, even when the input video signal is changed, the gain is caused to respond at low speed so that the value of the immediately previous frame is maintained.

The example of the configuration of the temporal direction control unit 112 performing the above-described process has been described with reference to FIG. 11.

### 2-3. PROCESS PERFORMED BY CONTROL VALUE SELECTION UNIT 110 (FIG. 12)

Next, an example of the configuration of the control value selection unit 110 will be described below with reference to FIG. 12. FIG. 12 is a diagram illustrating an example of the configuration of the control value selection unit 110 according to this embodiment.

As described above, the control value selection unit 110 outputs the response control value V_{C} to the temporal direction control unit 112. Hereinafter, a case in which a value V_{C1} selected from binary values of K₁ and K₂ which are values set in advance by the control value selection unit 110 is output as the response control value V_{C} to the temporal direction control unit 112 will be described.

The value K₁ is a response control value used to cause the temporal direction control unit 112 to perform the response control at high speed and is set to, for example, about 0. Further, the value K₂ is a response control value used to cause the temporal direction control unit 112 to perform the response control at low speed and is set to, for example, about 0.9.

As shown in FIG. 12, an inter-frame difference D input to the control value selection unit 110 is input to a determination unit 132 of the control value selection unit 110. The determination unit 132 determines whether the inter-frame difference D is greater than the threshold value TH set in advance.

When the inter-frame difference D is greater than the threshold value TH, the determination unit 132 outputs 1 (true) to a selector 134. Conversely, when the inter-frame difference D is equal to or less than the threshold value TH, the determination unit 132 outputs 0 (false) to the selector 134.

When 1 is input from the determination unit 132, the selector 134 selects the value K₁ used to perform the high-speed response control as the response control value V_{C1} and outputs the value K₁ to the multiplication unit 124 of the temporal direction control unit 112. Conversely, when 0 is input from the determination unit 132, the selector 134 selects the value K₂ used to perform the low-speed response control as the response control value V_{C1} and outputs the value K₂ to the multiplication unit 124 of the temporal direction control unit 112.

The case in which the response control value K₁ is set to about 0 has been described, but the embodiment of the present disclosure is not limited thereto. The value may be a response control value used to cause the gain to respond at high speed. Further, the case in which the response control value K₂ is set to about 0.9 has been described, but the embodiment of the present disclosure is not limited thereto. The value may he a response control value used to cause the gain to respond at low speed.

The example of the configuration of the control value selection unit 110 has been described with reference to FIG. 12.

### 2-4. FLOW OF PROCESS

### 2-4-1. FLOW OF PROCESS PERFORMED BY ABL CONTROL UNIT 100 (FIG. 13)

Next, the flow of a process performed by the ABL control unit 100 will be described below with reference to FIG. 13. FIG. 13 is a diagram illustrating an example of the flow of a process performed by the ABL control unit 100 according to this embodiment.

As shown in FIG. 13, the linear conversion unit 102 first performs linear conversion on the input video signal (S102).

Next, the one-screen current average value calculation unit 104 calculates a one-screen current average value of each frame of the video signal obtained after the linear conversion (S104).

Next, the gain calculation unit 106 calculates the gain used to adjust the luminance of each frame based on the calculated one-screen current average value. (S106).

Next, the inter-frame difference calculation unit 108 calculates the difference (inter-frame difference) in the calculated one-screen current average value between the frames (S108).

Next, the control value selection unit 110 selects the response control value used to perform the response control of the temporal direction control unit 112 based on the calculated inter-frame difference (S110).

Next, the temporal direction control unit 112 performs the temporal direction response control of the calculated gain (S112). At this time, the response speed of the gain is adjusted by the temporal direction control unit 112.

Next, the gain control unit 114 performs the gain control of the signal input from the linear conversion unit 102 using the gain subjected to the temporal direction response control (S114). When the gain control unit 114 performs the gain control, the gain control unit 114 outputs the signal obtained after the gain control to the display control unit 116. Thereafter, the ABL control unit 100 ends the series of processes concerning the ABL control.

The flow of the process performed by the ABL control unit 100 has been described with reference to FIG. 13. The processing order of some processing steps may be switched.

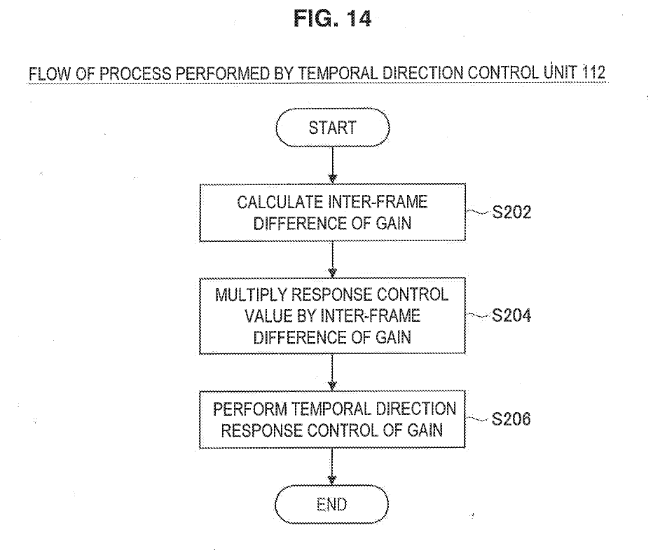

### (2-4-2. FLOW OF PROCESS PERFORMED BY TEMPORAL DIRECTION CONTROL UNIT 112 (FIG. 14)

Next, the flow of a process performed by the temporal direction control unit 112 will be described below with reference to FIG. 14. FIG. 14 is a diagram illustrating an example of the flow of the process performed by the temporal direction control unit 112 according to this embodiment.

As shown in FIG. 14, the temporal direction control unit 112 first calculates an inter-frame difference of the gain (S202). When the inter-frame difference is calculated, the value of the gain temporarily stored in the frame memory is used.

Next, the temporal direction control unit 112 multiplies the response control value selected by the control value selection unit 110 by the calculated inter-frame difference of the gain (S204).

Next, the temporal direction control unit 112 performs the temporal direction response control of the gain by adding the value calculated in step S204 and the value of the gain input to the temporal direction control unit 112 (S206).

The temporal direction control unit 112 adjusts the speed of the temporal direction response control of the gain according to the value of the input response control value. Further, the response control value is calculated based on the inter-frame difference in the one-screen current average value between the frames.

When the inter-frame difference in the average current value is large, the temporal direction control unit 112 causes the gain to respond at high speed in terms of the protection of the light-emitting element of the display unit 118 or the power source. On the other hand, when the inter-frame difference in the average current value is small, the temporal direction control unit 112 causes the gain to respond at low speed to prevent image quality from deteriorating.

When the temporal direction control unit 112 performs the temporal direction response control of the gain, the temporal direction control unit 112 outputs the controlled gain to the gain control unit 114 and ends the series of processes (S206).

The process performed by the temporal direction control unit 112 has been described with reference to FIG. 14.

### 2-4-3. FLOW OF PROCESS PERFORMED BY CONTROL VALUE SELECTION UNIT 110 (FIG. 15)

Next, the flow of a process performed by the control value selection unit 110 will be described with reference to FIG. 15. FIG. 15 is a diagram illustrating an example of the flow of the process performed by the control value selection unit 110 according to this embodiment.

As in FIG. 15, when the inter-frame difference D in the one-screen current average value is input (S302), the control value selection unit 110 determines whether the inter-frame difference D in the one-screen current average value is greater than the threshold value TH (S304).

When the inter-frame difference D in the one-screen current average value is greater than the threshold value TH, the control value selection unit 110 selects the value K₁ as the response control value V_{C1} (S306). Further, the value K₁ is a response control value used to cause the temporal direction control unit 112 to perform the response control at high speed and is set to, for example, about 0.

Conversely, when the inter-frame difference D in the one-screen current average value is equal to or less than the threshold value TH, the control value selection unit 110 selects the value K₂ as the response control value V_{C1} (S308). Further, the value K₂ is a response control value used to cause the temporal direction control unit 112 to perform the response control at low speed and is set to, for example, about 0.9.

The control value selection unit 110 outputs the selected response control value V_{C1} to the temporal direction control unit 112 and ends the series of processes (S310).

The flow of the process performed by the control value selection unit 110 has been described with reference to FIG. 15.

### 2-5. ADVANTAGES OF TEMPORAL DIRECTION CONTROL (FIG. 16)

Next, the advantages of this embodiment will be described with reference to FIGS. 5 and 16. FIG. 5 is the diagram illustrating the gain change caused due to the appearance or disappearance of a telop. FIG. 16 is a diagram illustrating the advantages of this embodiment. The horizontal axis of FIG. 16 represents a one-screen current average value I. The vertical axis of FIG. 16 represents a gain G_{OUT} obtained after the temporal direction control.

When the temporal direction response control is not performed, the gain is caused to respond to a change in the one-screen current average value of an input video signal at high speed. According to this embodiment, however, the gain can be caused to respond to a change in the one-screen current average value of an input video signal at high speed or at low speed.

Hereinafter, the ABL control performed when the luminance of only a part of an input video signal is changed due to, for example, appearance or disappearance of a telop will be described by comparing a case in which the temporal direction response control is not performed to a case in which the temporal direction response control is performed in this embodiment.

As described above with reference to FIG. 5, in the ABL control in which the temporal direction response control is not performed, the gain has considerably been changed even with the change in the one-screen current average value I caused due to the change in the luminance of only a part of a video signal such as appearance or disappearance of a telop.

On the other hand, in the ABL control of this embodiment in which the temporal direction response control is performed, as in FIG. 16, the value of the calculated gain G_{OUT} is maintained even when the one-screen current average value I is changed only by ΔI due to the appearance or disappearance of the telop. That is, according to this embodiment, it is possible to obtain the advantage of calculating the gain G_{OUT} while moving a graph of a function G_{OUT}=TH/I and a graph of a function G_{OUT}=translated in parallel only by ΔI from the graph.

This is the same when the ABL does not operate. That is, this means that the current value of a video signal output to the display unit 118 is changed with the change in the current value of the video signal input to the ABL control unit 100.

At this time, the change amount of the current value of the video signal output to the display unit 118 is the same as the change amount ΔI of the one-screen current average value I of the input video signal caused due to the appearance or disappearance of a telop.

Further, by predicting and setting the change amount of the threshold value which is a boundary (ABL point) of the one-screen current average value I for which the ABL control is performed beforehand, it is possible to prevent an overcurrent from flowing in the light-emitting element of the display unit 118 and also realize a high image quality of the display unit 118.

In a large-sized display device, particularly, humans can easily perceive deterioration in image quality caused due to a temporal-direction sharp change in the luminance of moving image contents continuous in the temporal direction in the ABL control. For this reason, in the case of a large-sized display device, the advantages obtained by applying the technology of this embodiment are particularly effective.

The advantages of this embodiment have been described with reference to FIG. 16.

### 3. MODIFICATION EXAMPLES

Although the basic configuration of the ABL control unit 100 according to this embodiment has been described, the application scope of the technology according to the embodiment is not limited thereto. For example, modification examples to be exemplified below are, of course, included in the application scope of the technology according to the embodiment.

### 3-1. FIRST MODIFICATION EXAMPLE

### Calculation of Response Control Value by Signal Conversion: FIG. 17

Next, a first modification example of the embodiment will be described below with reference to FIG. 17. An ABL control unit according to the first modification example has a configuration in which the control value selection unit 110 included in the basic configuration of the above-described ABL control unit 110 is substituted with a signal conversion unit 111 to be described below. Further, since the constituent units of the ABL control unit 100 other than the signal conversion unit 111 are the same as the above-described basic configuration, the description thereof will not be repeated.

FIG. 17 is a diagram for describing the first modification example of the technology of the embodiment. As shown in FIG. 17, the inter-frame difference D in the one-screen current average value calculated by the inter-frame difference calculation unit 108 is input to the signal conversion unit 111.

The signal conversion unit 111 converts the inter-frame difference D in the one-screen current average value into a response control value V_{C2}. A conversion method performed by the signal conversion unit 111 may be a conversion method of converting the inter-frame difference D in the one-screen current average value of a small value between the frames into the response control value V_{C2} used to perform the response control of slowing a response of the gain.

For example, when the minimum value D_{MIN} of the value of the inter-frame difference D in the one-screen current average value is input, the signal conversion unit 111 outputs 1 as the response control value V_{C2}. Further, when the maximum value D_{MAX} of the inter-frame difference D in the one-screen current average value is input, the signal conversion unit 111 outputs 0 as the response control value V_{C2}.

When a value other than the minimum value D_{MIN} and the maximum value D_{MAX} is input as the inter-frame difference D in the one-screen current average value, the signal conversion unit 111 performs linear conversion on the input value of the inter-frame difference D in the one-screen current average value and outputs a value between 0 and 1.

The above-described response control value V_{C2} output by the signal conversion unit 111 is not limited to a binary value of 0 or 1. Therefore, the response control of the gain corresponding to the inter-frame difference D in the one-screen current average value can be performed more appropriately.

### 3-2. SECOND MODIFICATION EXAMPLE

### Selection of Response Control Value Based on Two Threshold Values: FIG. 18

Next, a second modification example of the embodiment will be described below with reference to FIG. 18. This modification example relates to a configuration in which a response control value is selected based on two threshold values. In this modification example, the response control of the gain can be performed in consideration of not only a case in which the luminance of a video signal input to the ABL control unit 100 increases but also a case in which the luminance of the video signal decreases.

The ABL control unit according to this modification example has a configuration in which the inter-frame difference calculation unit 108 included in the basic configuration of the above-described ABL control unit 100 is substituted with an inter-frame difference calculation unit 208 and the control value selection unit 110 is substituted with a control value selection unit 210.

FIG. 18 is a diagram for describing this modification example. First, the inter-frame difference calculation unit 208 will be described.

As shown in FIG. 18, the inter-frame difference calculation unit 208 stores a one-screen current average value I in a frame memory FM2. At a moment at which the one-screen current average value I of a given frame is input to the inter-frame difference calculation unit 208, the frame memory FM2 stores the one-screen current average value I of a frame input to the inter-frame difference calculation unit 208 immediately before the given frame.

An addition unit 222 of the inter-frame difference calculation unit 208 adds a value obtained by inverting the sign of the one-screen current average value I input at a given moment and the value stored in the frame memory FM2. The addition unit 222 outputs a calculated value D₁ to a determination unit 232 of a control value selection unit 210.

Here, when the luminance of a video input to the ABL control unit 100 decreases (in other words, when the frame is switched from a bright frame to a dark frame), the sign of the output value D₁ of the addition unit 222 become positive.

Further, an addition unit 224 of the hater-frame difference calculation unit 208 adds the one-screen current average value I input at a given moment and a value obtained by inverting the value stored in the frame memory FM2. The addition unit 224 outputs a calculated value D₂ to determination units 236 and 240 of the control value selection unit 210.

Here, when the luminance of a video input to the ABL control unit 100 increases (in other words_{;} when the frame is switched from a dark frame to a bright frame), the sign of the output value D₂ of the addition unit 224 becomes positive.

The output value D₁ of the addition unit 222 and the output value D₂ of the addition unit 224 are values which have the same absolute value and opposite signs.

The process performed by the inter-frame difference calculation unit 208 has been described.

Next, a process performed by the control value selection unit 210 will be described. A determination unit 232 of the control value selection unit 210 determines whether the input value D₁ is greater than a preset threshold value TH₁.

When the input value D₁ is greater the threshold value TH₁, the determination unit 232 outputs 1 (true) to a selector 234, Conversely, when the input value D₁ is equal to or less than the threshold value TH₁, the determination unit 232 outputs 0 (false) to the selector 234.

The selector 234 selects one of values K_{D1} and K_{D2} as a response control value V_{C3D}. The value K_{D1} is a response control value used to cause the temporal direction control unit 112 to perform the response control at high speed and is set to, for example, about 0. Further, the value K_{D2} is a response control value used to cause the temporal direction control unit 112 to perform the response control at low speed and is set to, for example, about 0.9.

When 1 is input from the determination unit 232, the selector 234 selects the value K_{D1} used for the response control of the high speed as the response control value V_{C3D} and outputs the response control value V_{C3D} to a selector 242. On the other hand, when 0 is input from the determination unit 232, the selector 234 selects the value K_{D2} used for the response control of the low speed as the response control value V_{C3D} and outputs the response control value V_{C3D} to a selector 242.

A determination unit 236 determines whether the input value D₂ is greater than a preset threshold value TH₂.

When the input value D₂ is greater than the threshold value TH2, the determination unit 236 outputs 1 (true) to a selector 238. Conversely, when the input value D₂ is equal to or less than the threshold value TH2, the determination unit 236 outputs 0 (false) to the selector 238.

The selector 238 selects one of values K_{U1} and K_{U2} as a response control value V_{C3U}. The value K_{U1} is a response control value used to cause the temporal direction control unit 112 to perform the response control at high speed and is set to, for example, about 0. Further, the value K_{U2} is a response control value used to cause the temporal direction control unit 112 to perform the response control at low speed and is set to, for example, about 0.9.

When 1 is input from the determination unit 236, the selector 238 selects the value K_{D1} used for the response control of the high speed as the response control value V_{C3D} and outputs the response control value V_{C3D} to the selector 242. On the other hand, when 0 is input from the determination unit 236, the selector 236 selects the value K_{D2} used for the response control of the low speed as the response control value V_{C3D} and outputs the response control value V_{C3D} to the selector 242.

A determination unit 240 determines whether the input value D₂ is positive. When a video signal input to the ABL control unit 100 is changed from a dark frame to a bright frame, the value D₂ becomes positive. In this case, the determination unit 240 outputs 1 (true) to the selector 242.

On the other hand, when the video signal input to the ABL control unit 100 is changed from a bright frame to a dark frame, the value D₂ becomes negative. In this case, the determination unit 240 outputs 0 (false) to the selector 242.

As described above, the response control value V_{C3D} selected based on the value D₁ between the inter-frame differences and the response control value V_{C3U} selected based on the value D₂ are input to the selector 242. The selector 242 selects one of the two response control values V_{C3D} and V_{C3U} based on the binary value of 1 or 0 input from the determination unit 240.

The value D₁ becomes positive when the frame is switched from the bright frame to the dark frame. Further, the value D₂ becomes positive when the frame is switched from the dark frame to the bright frame.

The selector 242 selects the response control value V_{C3D} selected based on the value D₁ when the frame is switched from the bright frame to the dark frame. That is, the selector 242 selects the response control value V_{C3D} when 0 is input from the determination unit 240.

The selector 242 selects the response control value V_{C3U} selected based on the value D₂ when the frame is switched from the dark frame to the bright frame. That is, the selector 242 selects the response control value V_{C3U} when I is input from the determination unit 240.

The selector 242 outputs the selected response control value V_{C3} to the temporal direction control unit 112.

The second modification example of the embodiment has been described with reference to FIG. 18. According to this modification example, as described above, the temporal direction response control of the gain can be performed not only when the video signal input to the. ABL control unit 100 is changed from the dark frame to the bright frame but also when the video signal is changed from the bright frame to the dark frame.

Of course, the threshold value TH1 of the determination unit 232 and the threshold value TH2 of the determination unit 236 may be set to other values. Hereinafter, an example in which the threshold value TH1 is set to a value greater than the threshold value TH2 will be described.

On the assumption that the threshold value TH1 is set to a large value, there is a high possibility of the determination unit 232 outputting 0 (false) when the video signal input to the ABL control unit 100 is changed from the bright frame to the dark frame, hi this case, there is a high possibility of the selector 234 selecting the response control value K_{D2} used to cause the gain to respond at low speed.

Conversely, on the assumption that the threshold value TH2 is set to a small value, there is a high possibility of the determination unit 236 outputting 1 (true) when the video signal input to the ABL control unit 100 is changed from the dark frame to the bright frame. In this case, there is a high possibility of the selector 238 selecting the response control value K_{U1} used to cause the gain to respond at high speed.

According to this modification example, when the frame is switched from the dark frame to the bright frame, it is possible to cause the gain to respond to the change in the input video signal at high speed by prioritizing prevention of an overcurrent in the light-emitting element of the display unit 118 or the power source. On the other hand, when the frame is switched from the bright frame to the dark frame, it is possible to cause the gain to respond to the change in the input video signal at low speed by prioritizing an image quality since there is a low necessity to protect the display unit 118.

Thus, according to this modification example, it is possible to achieve both of high image quality and the prevention of an overcurrent.

### 3-3. THIRD MODIFICATION EXAMPLE

### Use of Telop Presence and Absence Information FIG. 19

Next, a third modification example of the embodiment will be described below with reference to FIG. 19. An ABL control unit 300 according to the third modification example has a configuration in which the inter-frame difference calculation unit 108 included in the basic configuration of the above-described ABL control unit 100 is deleted and a telop appearance or disappearance determination unit 308 to be described below is added. FIG. 19 is a diagram for describing this modification example.

A linear conversion unit 102 outputs a video signal obtained after linear conversion not only to a one-screen current average value calculation unit 104 but also to the telop appearance and disappearance determination unit 308. The telop appearance and disappearance determination unit 308 determines whether a telop is included in each frame of the video signal input to the ABL control unit 300. The telop appearance and disappearance determination unit 308 determines the appearance or disappearance of the telop of the input signal, for example, by performing a process of detecting an edge of the input video signal and detecting a character included in the telop using the edge detection result.

A method of detecting a telop is disclosed in, for example, Japanese Unexamined Patent Application Publication No. 2009-038671.

The telop appearance and disappearance determination unit 308 outputs 0 to a control value selection unit 110 when detecting the appearance or disappearance of the telop. The telop appearance and disappearance determination unit 308 outputs 1 to the control value selection 110 when not detecting the appearance or disappearance of the telop.

When the telop appearance and disappearance determination unit 308 is combined, the determination unit 132 of the control value selection unit 110 is deleted and the value input from the telop appearance and disappearance determination unit 308 is input directly to a selector 134 of the control value selection unit 110.

When the appearance or disappearance of the telop is detected, 0 is input to the selector 134. In this case, the selector 134 selects a value K₂ used to perform control of causing the gain to respond at low speed as a response control value V_{C}. Further, when the appearance or disappearance of the telop is not detected, 1 is input to the selector 134. In this case, the selector 134 selects a value K₁ used to perform control of causing the gain to respond at high speed as the response control value V_{C}.

According to this modification example, the appearance or disappearance of the telop is directly determined before the control of the response speed of the gain. Therefore, the control of the response speed of the gain for the appearance or disappearance of the telop can be performed more appropriately.

The third modification example of the embodiment has been described with reference to FIG. 19.

### 3-4. FOURTH MODIFICATION EXAMPLE

### Use of Codec Information: FIG. 20

Next, a fourth modification example of the embodiment will be described below with reference to FIG. 20. An ABL control unit 400 according to the fourth modification example has a configuration in which the inter-frame difference calculation unit 108 included in the basic configuration of the above-described ABL control unit 100 is deleted and a codec information acquisition unit 408 to be described below is added. FIG. 20 is a diagram for describing this modification example,

The codec information acquisition unit 408 acquires codec information of each frame of a video signal input to the ABL control unit 300. In general, a video signal input to a display device is input in an encoded state. Therefore, the display device includes a codec that encodes and decodes a signal.

The codec information acquisition unit 408 acquires codec information obtained through encoding from a codec that is included in the display device 10 and decodes an input video signal. For example, the codec information includes information regarding an inter-frame difference or information regarding an object motion vector included in an input video.

For example, the information regarding the inter-frame difference included in the codec information is processed by the control value selection unit 110, as in the output value of the inter-frame difference calculation unit 108 in the basic configuration of the ABL control unit 100.

It can be understood that an object included in a given frame is not included in the subsequent frame from the information regarding the object motion vector included in the code information. Therefore, the object motion vector included in the codec information can be used to detect a change in a video signal.

For example, when the object motion vector is small, a change in luminance can easily be perceived by humans. Therefore, 0 may be output to the control value selection unit 110 to prioritize an image quality and cause the gain to respond at low speed.

On the other hand, when the object motion vector is large, 1 may be output to the control value selection unit 110 to prioritize the protection of the light-emitting element of the display unit 118 and cause the gain to respond at high speed.

When the codec information acquisition unit 408 is combined, the determination unit 132 of the control value selection unit 110 is deleted, and the value input from the codec information acquisition unit 408 is input directly to the selector 134 of the control value selection unit 110.

When 0 is input to the selector 134, the selector 134 selects the value K₂ used to perform control of causing the gain to respond at low speed as the response control value V_{C}. Further, when 1 is input to the selector 134, the selector 134 selects the value K₁ used to perform control of causing the gain to respond at high speed as the response control value V_{C}.

According to this modification example, it is possible to effectively use the code information used to encode and decode a video signal and control the response speed of the gain with respect to the change of the input video signal.

The fourth modification example of the embodiment has been described with reference to FIG. 20.

### 4. SUMMARIZATION

Finally, the technical spirit and essence of the embodiment will be described in brief. The technical spirit and essence to be described below can be applied to, for example, a self-luminous type display device and a cellular phone, a game device, an information terminal, a personal computer, or the like having the same display function as the display device.

For example, in a display device to be described below in (1), when an input video signal sharply increases, a gain used to control the video signal responds to the input video signal at high speed. As a result, an overcurrent is prevented from flowing in a light-emitting element or a power source. On the other hand, when the input video signal gently increases, a gain used to control the video signal responds to the input video signal at low speed. As a result, the luminance of a screen of the display device is stabilized and image quality is prevented from deteriorating.
(1) A Display Device Including:

a temporal direction control unit that causes a gain used to control a video signal to respond to an input video signal at high speed when the input video signal sharply increases, and causes the gain to respond to the input video signal at low speed when the input video signal gently increases.
(2) The Display Device According to (1), Further Including:

a control value selection unit that selects a response control value used to adjust the speed at which the gain is caused to respond to the input video signal based on a difference in a current value between frames,

wherein, based on the response control value, the temporal direction control unit adjusts the speed at which the gain is caused to respond to the input video signal.
(3) The Display Device According to (1), Further Including:

a control value selection unit that selects a high-speed response control value used to cause the gain to respond to the input video signal at the high speed when a telop appears or disappears, and selects a low-speed response control value used to cause the gain to respond to the input video signal at the low speed when the telop does not appear or disappear,

wherein, based on the response control value, the temporal direction control unit adjusts the speed at which the gain is caused to respond to the input video signal.
(4) The Display Device According to (1), Further Including:

a control value selection unit that selects a response control value used to adjust the speed at which the gain is caused to respond to the input video signal based on codec information,

wherein, based on the response control value, the temporal direction control unit adjusts the speed at which the gain is caused to respond to the input video signal.
(5) The display device according to (2), wherein the control value selection unit selects a high-speed control value used to cause the gain to respond to the input video signal at the high speed when an increase amount of the current value between the frames is greater than a predetermined threshold value, and selects a low-speed control value used to cause the gain to respond to the input video signal at the low speed when the increase amount of the current value between the frames is less than the predetermined threshold value.
(6) The Display Device According to (2), Further Including:

a signal conversion unit that converts the increase amount of the current value between the frames into the response control value which is a continuous value used to adjust the speed at which the gain is caused to respond to the input video signal,

wherein, based on the response control value, the temporal direction control unit adjusts the speed at which the gain is caused to respond to the input video signal.
(7) The Display Device According to (2),

wherein the control value selection unit selects a first high-speed response control value as the response control value used to cause the gain to respond to the input video signal at the high speed when the current value between the frames decreases and a decrease amount of the current value is greater than a first threshold value,

wherein the control value selection unit selects a first low-speed response control value as the response control value used to cause the gain to respond to the input video signal at the low speed when the current value between the frames decreases and the decrease amount of the current value is less than the first threshold value,

wherein the control value selection unit selects a second high-speed response control value as the response control value used to cause the gain to respond to the input video signal at the high speed when the current value between the frames increases and the increase amount of the current value is greater than a second threshold value, and

wherein the control value selection unit selects a second low-speed response control value as the response control value used to cause the gain to respond to the input video signal at the low speed when the current value between the frames increases and the increase amount of the current value is less than the second threshold value.
(8) The Display Device According to Any One of (1) to (7), Further Including:

a display unit that includes a self-luminous type light-emitting element; and

a display control unit that controls display of the display unit in accordance with the input video signal subjected to gain adjustment.
(9) An Integrated Circuit Having a Temporal Direction Control Function of Causing a gain used to control a video signal to respond to an input video signal at high speed when the input video signal sharply increases, and causes the gain to respond to the input video signal at low speed when the input video signal gently increases.
(10) A Control Method Including:

causing a gain used to control a video signal to respond to an input video signal at high speed when the input video signal sharply increases, and causes the gain to respond to the input video signal at low speed when the input video signal gently increases.

It should be understood by those skilled in the art that various modifications, combinations, sub-combinations and alterations may occur depending on design requirements and other factors insofar as they are within the scope of the appended claims or the equivalents thereof.

The present disclosure contains subject matter related to that disclosed in Japanese Priority Patent Application JP 2012-067034 filed in the Japan Patent Office on Mar. 23, 2012, the entire content of which is hereby incorporated by reference.

What is claimed is:

1. A display device comprising:
a temporal direction control unit that causes a gain used to control a video signal to respond to an input video signal at high speed when the input video signal sharply increases, and causes the gain to respond to the input video signal at low speed when the input video signal gently increases.

2. The display device according to claim 1, further comprising:
a control value selection unit that selects a response control value used to adjust the speed at which the gain is caused to respond to the input video signal based on a difference in a current value between frames,
wherein, based on the response control value, the temporal direction control unit adjusts the speed at which the gain is caused to respond to the input video signal.

3. The display device according to claim 1, further comprising:
a control value selection unit that selects a high-speed response control value used to cause the gain to respond to the input video signal at the high speed when a telop appears or disappears, and selects a low-speed response control value used to cause the gain to respond to the input video signal at the low-speed when the telop does not appear or disappear,
wherein, based on the response control value, the temporal direction control unit adjusts the speed at which the gain is caused to respond to the input video signal.

4. The display device according to claim 1, further comprising:
a control value selection unit that selects a response control value used to adjust the speed at which the gain is caused to respond to the input video signal based on codec information,
wherein, based on the response control value, the temporal direction control unit adjusts the speed at which the gain is caused to respond to the input video signal.

5. The display device according to claim 2, wherein the control value selection unit selects a high-speed control value used to cause the gain to respond to the input video signal at the high speed when an increase amount of the current value between the frames is greater than a predetermined threshold value, and selects a low-speed control value used to cause the gain to respond to the input video signal at the low speed when the increase amount of the current value between the frames is less than the predetermined threshold value.

6. The display device according to claim 2, further comprising:
a signal conversion unit that converts the increase amount of the current value between the frames into the response control value which is a continuous value used to adjust the speed at which the gain is caused to respond to the input video signal,
wherein, based on the response control value, the temporal direction control unit adjusts the speed at which the gain is caused to respond to the input video signal.

7. The display device according to claim 2,
wherein the control value selection unit selects a first high-speed response control value as the response control value used to cause the gain to respond to the input video signal at the high speed when the current value between the frames decreases and a decrease amount of the current value is greater than a first threshold value,
wherein the control value selection unit selects a first low-speed response control value as the response control value used to cause the gain to respond to the input video signal at the low speed when the current value between the frames decreases and the decrease amount of the current value is less than the first threshold value,
wherein the control value selection unit selects a second high-speed response control value as the response control value used to cause the gain to respond to the input video signal at the high speed when the current value between the frames increases and the increase amount of the current value is greater than a second threshold value, and
wherein the control value selection unit selects a second low-speed response control value as the response control value used to cause the gain to respond to the input video signal at the low speed when the current value between the frames increases and the increase amount of the current value is less than the second threshold value.

8. The display device according to claim 1, further comprising:
a display unit that includes a self-luminous type light-emitting element; and
a display control unit that controls display of the display unit in accordance with the input video signal subjected to gain adjustment.

9. An integrated circuit having a temporal direction control function of causing a gain used to control a video signal to respond to an input video signal at high speed when the input video signal sharply increases, and causes the gain to respond to the input video signal at low speed when the input video signal gently increases.

10. A control method comprising:
causing a gain used to control a video signal to respond to an input video signal at high speed when the input video signal sharply increases, and causes the gain to respond to the input video signal at low speed when the input video signal gently increases.
